(19) United States
(12) Patent Application Publication
(10) Pub. No.: US 2023/0175411 A1
(43) Pub. Date: Jun. 8, 2023

(54) ROTARY MACHINE

(71) Applicant: MITSUBISHI HEAVY INDUSTRIES, LTD., Tokyo (JP)

(72) Inventors: Makoto IWASAKI, Tokyo (JP); Motomu ASAHARA, Tokyo (JP); Naoto OMURA, Tokyo (JP)

(73) Assignee: MITSUBISHI HEAVY INDUSTRIES, LTD., Tokyo (JP)

(21) Appl. No.: 17/989,503

(22) Filed: Nov. 17, 2022

(30) Foreign Application Priority Data
Dec. 7, 2021 (JP) 2021-198839

(51) Int. Cl. F01D 11/02

(52) U.S. Cl. CPC F01D 11/02; F05D 2240/55; F05D 2220/31

(57) ABSTRACT

The rotary machine includes a rotor, an annular member disposed on an outer circumferential side of the rotor, and a hole pattern seal fixed to the annular member and partitioning a space between the rotor and the annular member into a high-pressure side and a low-pressure side. The hole pattern seal has an annular seal main body covering an outer circumference of the rotor, a hole group provided on an inner circumferential surface of the seal main body, and having holes being aligned at intervals in the direction of an axis of the rotor and a circumferential direction of the axis, and fin sections provided on the inner circumferential surface of the seal main body throughout in the circumferential direction, each of the fin sections having the thickness equal to or smaller than that of the thinnest part of the seal main body, wherein the fin sections are provided on at least the high-pressure side and the low-pressure side of the seal main body.

### BACKGROUND OF THE INVENTION

### Field of the Invention

The present disclosure relates to a rotary machine.

Priority is claimed on Japanese Patent Application No. 2021-198839, filed Dec. 7, 2021, the content of which is incorporated herein by reference.

### Description of Related Art

In a rotary machine such as a turbine or the like, in order to prevent leakage of a fluid from a gap between a stationary side and a rotary side thereof, a seal flow channel is provided in an outer circumferential surface of the rotor. A swirl having a velocity component in a circumferential direction is generated by rotation of the rotor in the seal flow channel. When a displacement is generated in the rotor and the swirl in the seal flow channel is comparatively large, an exciting force in a direction perpendicular to the displacement of the rotor is applied to the rotor. The exciting force accelerates run-out of the rotor, deteriorates the stability of the shafting, and causes unstable self-excited oscillation. For this reason, it is strongly preferable to reduce the swirl and suppress the self-excited oscillation.

For example, International PCT Publication No. 2014/077058 discloses a rotary machine including a hole pattern seal configured to partition a space between a rotating shaft (rotor) and a stator into a high pressure side and a low pressure side of the space and having a hole array with a plurality of holes facing an outer circumferential surface of the rotor at intervals in the circumferential direction. The hole pattern seal has a fin section protruding toward a rotating shaft on the high pressure side of the hole array and extending in the circumferential direction, and the rotor includes a protruding section protruding from the outer circumferential surface toward the hole to extend in the circumferential direction and facing the hole on the low pressure side of the fin section. Accordingly, the fluid that enters from the gap between the fin section and the rotor is brought into contact with the protruding section of the rotor and flows toward the hole of the hole pattern seal, and thus, it is possible to inhibit the flow of the fluid in a turning direction and reduce the swirl. As a result, the self-excited oscillation by the swirl is suppressed. In addition, in such a hole pattern seal, a large damping effect is obtained due to momentum fluctuation caused by the swirl or the like generated in the hole.

Hereinafter, suppression of the self-excited oscillation is referred to as damping.

### SUMMARY OF THE INVENTION

Incidentally, when a displacement occurs in the rotor, the hole pattern seal and the rotor may come into contact with each other within a wide range of the fin section and the protruding section. In this case, it is expected that the contact heat between the hole pattern seal and the rotor will deform the rotor to increase eccentricity (unbalance) of the rotor and forced vibrations (unbalance vibrations) will increase. There is still room for improvement in terms of improving damping while reducing a risk of contact between the hole pattern seal and the rotor.

In consideration of the above-mentioned circumstances, the present disclosure is directed to providing a rotary machine capable of improving damping while reducing a contact risk between a hole pattern seal and a rotor.

In order to solve the above-mentioned problems, one rotary machine according to the present disclosure includes a rotor lying in a direction of an axis and having an outer circumferential surface with a uniform outer diameter throughout in the direction of the axis; an annular member which is disposed on an outer circumferential side of the rotor and which is allowed to rotate relative to the rotor around the axis; and a hole pattern seal which is fixed to the annular member and partitioning a space between the rotor and the annular member into a high-pressure side close to one end of the hole pattern seal and a low-pressure side close to the other end, the hole pattern seal being provided with: an annular seal main body covering an outer circumference of the rotor; a hole group which is provided on an inner circumferential surface of the seal main body and having a plurality of holes facing the outer circumferential surface of the rotor, the plurality of holes being aligned at intervals in the direction of the axis and a circumferential direction of the axis; and fin sections which are provided on the inner circumferential surface of the seal main body throughout in the circumferential direction and each protruding toward the rotor, each of the fin sections having the thickness in the direction of the axis equal to or smaller than that of the thinnest part of the seal main body, wherein the fin sections are provided on at least the high-pressure side and the low-pressure side of the seal main body in the direction of the axis.

Another rotary machine according to the present disclosure includes a rotor lying in a direction of an axis and having an outer circumferential surface with a uniform outer diameter throughout in the direction of the axis; an annular member which is disposed on an outer circumferential side of the rotor and which is allowed to rotate relative to the rotor around the axis; and a hole pattern seal which is fixed to the annular member and partitioning a space between the rotor and the annular member into a high-pressure side close to one end of the hole pattern seal and a low-pressure side close to the other end, wherein the hole pattern seal being provided with: an annular seal main body covering an outer circumference of the rotor; a plurality of holes formed on an inner circumferential surface of the seal main body at intervals in the direction of the axis and a circumferential direction of the axis and facing the outer circumferential surface of the rotor; fin sections which are provided on the inner circumferential surface of the seal main body throughout in the circumferential direction and each protruding toward the rotor, and each of the fin sections having the thickness in the direction of the axis equal to or smaller than that of the thinnest part of the seal main body, wherein the plurality of holes being arranged on polygonal grids, and each fin section is formed so as to surround the entire circumference of an opening portion of each of the holes arranged on the polygonal grids and has a shape tapered toward the rotor.

According to the rotary machine of the present disclosure, it is possible to improve damping while reducing a contact risk between the hole pattern seal and the rotor.

### BRIEF DESCRIPTION OF THE DRAWINGS

FIG. 1 is a schematic view showing a steam turbine according to a first embodiment of the present disclosure.

FIG. 2 is a perspective view showing a hole pattern seal according to the first embodiment of the present disclosure.

FIG. 3 is a partial cross-sectional view of the hole pattern seal according to the first embodiment of the present disclosure when seen in a circumferential direction.

FIG. 4 is an enlarged view of a hole of the high pressure side of FIG. 3.

FIG. 5 is a partial deployment view of an inner circumferential surface of the hole pattern seal according to the first embodiment of the present disclosure.

FIG. 6 is a view for describing a flow of steam in the hole according to the first embodiment of the present disclosure.

FIG. 7 is a partial cross-sectional view of a hole pattern seal according to a second embodiment of the present disclosure when seen in a circumferential direction.

FIG. 8 is a partial deployment view of an inner circumferential surface of the hole pattern seal according to the second embodiment of the present disclosure.

FIG. 9 is a partial deployment view of an inner circumferential surface of a hole pattern seal according to a third embodiment of the present disclosure.

FIG. 10 is an enlarged perspective view showing slits of the hole pattern seal according to the third embodiment of the present disclosure.

FIG. 11 is a plan view for describing a flow of steam in a hole according to the third embodiment of the present disclosure.

FIG. 12 is a partial cross-sectional view of a hole pattern seal according to a fourth embodiment of the present disclosure when seen in a circumferential direction.

FIG. 13 is a partial cross-sectional view showing the hole pattern seal according to the fourth embodiment of the present disclosure when seen from a high pressure side in an axial direction.

FIG. 14 is a partial deployment view of an inner circumferential surface of a hole pattern seal according to a fifth embodiment of the present disclosure.

FIG. 15 is an enlarged view showing holes and fin sections of FIG. 14.

FIG. 16 is a partial deployment view of an inner circumferential surface of a hole pattern seal according to a sixth embodiment of the present disclosure.

FIG. 17 is a partial cross-sectional view of the hole pattern seal corresponding to a place along line A-A in FIG. 16 when seen in the circumferential direction.

FIG. 18 is a partial cross-sectional view around a swirl brake according to a seventh embodiment of the present disclosure.

FIG. 19 is a view showing the swirl brake according to the seventh embodiment of the present disclosure from a high pressure side in the axial direction.

### DETAILED DESCRIPTION OF THE INVENTION

### First Embodiment

(Rotary Machine)

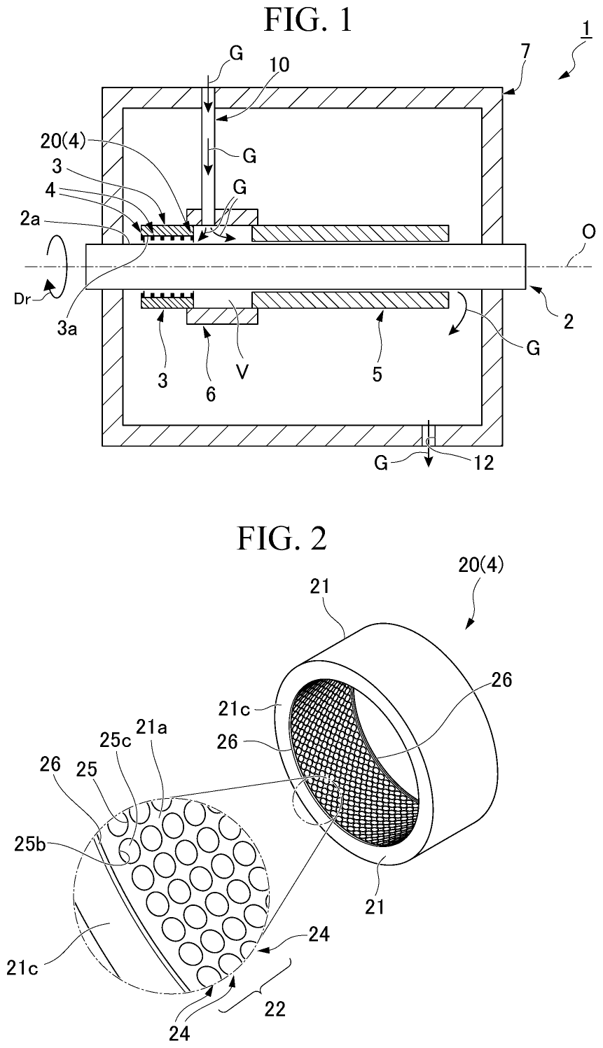

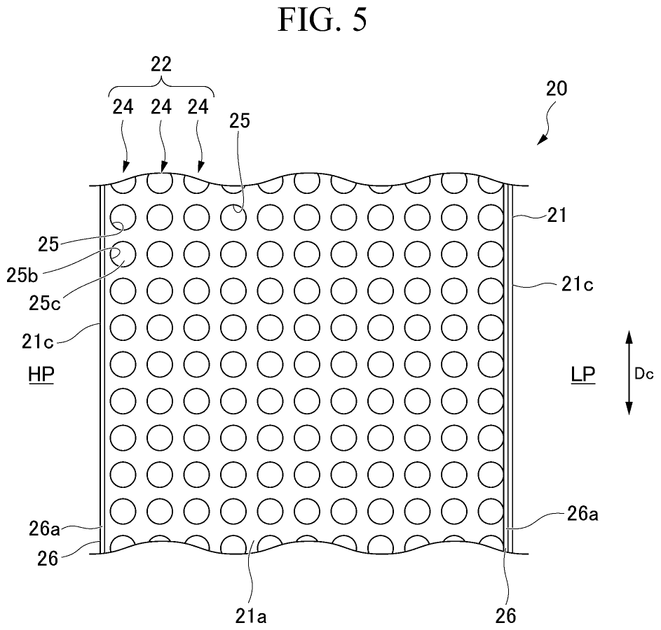

Hereinafter, a rotary machine according to a first embodiment of the present disclosure will be described with reference to FIG. 1 to FIG. 6.

As shown in FIG. 1, a steam turbine 1 (an example of a rotary machine) according to the embodiment includes a rotor 2 supported to be rotatable around an axis O, a dummy ring 3 (an example of an annular member) surrounding an outer circumference of the rotor 2, a seal member 4 provided on an inner circumferential surface 3a of the dummy ring 3, a blade ring 5 disposed with respect to the dummy ring 3 at intervals in a direction of the axis O, an inner wheel chamber 6 surrounding at least a part of an outer circumference of each of the dummy ring 3 and the blade ring 5, an outer wheel chamber 7 accommodating the dummy ring 3, the blade ring 5 and the inner wheel chamber 6 therein, and a steam supply pipe 10 provided between the inner wheel chamber 6 and the outer wheel chamber 7.

Hereinafter, a circumferential direction Dc around the axis O is referred to as “the circumferential direction Dc” and a radial direction with respect to the axis O is simply referred to as “the radial direction.”

(Rotor)

The rotor 2 is formed in a columnar shape centered about the axis O. The rotor 2 is lying in the direction of the axis O. The rotor 2 has an outer circumferential surface 2a with a uniform outer diameter throughout the entirety of the rotor 2 in the direction of the axis O. The rotor 2 is passed through the outer wheel chamber 7 in the direction of the axis O. The dummy ring 3, the inner wheel chamber 6 and the blade ring 5 are sequentially positioned in the outer wheel chamber 7 to surround the outer circumferential surface 2a of the rotor 2 from one side toward the other side in the direction of the axis O.

(Dummy Ring)

The dummy ring 3 is disposed on an outer circumferential side of the rotor 2 and fixed to an inner side of the outer wheel chamber 7. A slight gap is formed between the inner circumferential surface 3a of the dummy ring 3 and the outer circumferential surface 2a of the rotor 2. The seal member 4 is provided on the inner circumferential surface 3a of the dummy ring 3. Steam G flowing between the rotor 2 and the dummy ring 3 is sealed by the seal member 4. Five seal members 4 are provided in the direction of the axis O. One of the five seal members 4, which is located closest to the blade ring 5 in the direction of the axis O, acts as a hole pattern seal 20.

While not shown in detail, the blade ring 5 has a plurality of stationary blade arrays (not shown) arranged in the direction of the axis O. Each of the stationary blade arrays has a plurality of stationary blades arranged with respect to the axis O in the circumferential direction Dc. A plurality of rotor blade arrays (not shown) arranged at intervals in the direction of the axis O are provided on the outer circumferential surface 2a of the rotor 2 to enter between the stationary blade arrays. Each of the rotor blade arrays has a plurality of rotor blades arranged with respect to the axis O in the circumferential direction Dc.

At least part of each of the outer circumferential surface of the dummy ring 3 and the outer circumferential surface of the blade ring 5 is surrounded by the annular inner wheel chamber 6 from the outside. A space (a supply space V) on the inner circumferential side of the wheel chamber 6 and outside of the outer wheel chamber 7 are made to be communicating by the steam supply pipe 10. The steam G is supplied from an external steam supply source (not shown) to the steam turbine 1 through the steam supply pipe 10. The steam supplied through the steam supply pipe 10 flows toward both sides in the direction of the axis O via the supply space V and flows toward the inner circumferential side of the dummy ring 3 and the inner circumferential side of the blade ring 5.

When the steam G flows to the inner circumferential side of the blade ring 5, a rotating force is applied to the rotor 2 through the stationary blade array and the rotor blade array. Accordingly, the rotor 2 rotates in a rotating direction Dr counterclockwise about the axis O when seen from the side of the blade ring 5. Here, the dummy ring 3 is fixed into the outer wheel chamber 7. For this reason, the dummy ring 3 is rotated relative to the rotor 2 around the axis O. Rotation of the rotor 2 is extracted from a shaft end to drive external equipment (not shown) such as a generator or the like. The steam G passing through the blade ring 5 is discharged to the outside (for example, a condenser or the like, which is not shown) via an exhaust port 12 formed at the outer wheel chamber 7.

(Hole Pattern Seal)

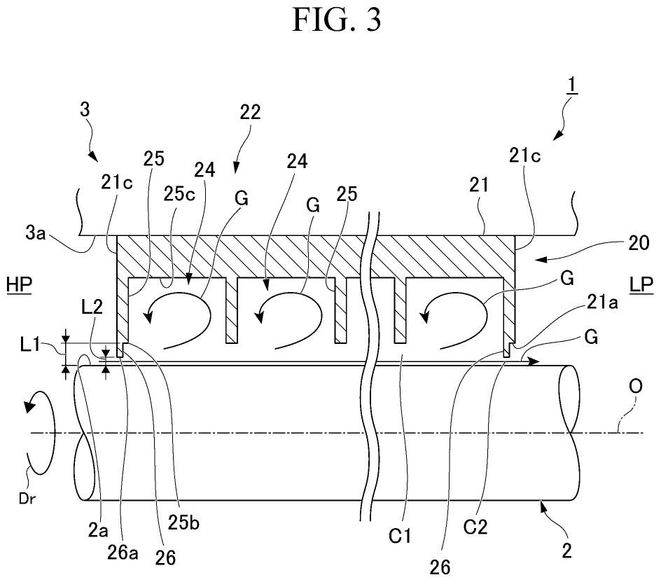

The hole pattern seal 20 is fixed to the inner circumferential surface 3a of the dummy ring 3. As shown in FIG. 2 and FIG. 3, the hole pattern seal 20 is formed in an annular shape and partitioning a space between the rotor 2 and the dummy ring 3 into a high pressure side HP close to one end of the hole pattern seal 20 and a low pressure side LP close to the other end in the direction of the axis O. A side of the supply space V in the direction of the axis O is the high pressure side HP and the side opposite to the supply space V in the direction of the axis O is the low pressure side LP while they sandwich the hole pattern seal 20. The hole pattern seal 20 has an annular seal main body 21 covering a circumference of the outer circumferential surface 2a of the rotor 2, a hole group 22 which is provided on an inner circumferential surface 21a of the seal main body 21 and having a plurality of holes 25 aligned at intervals in the direction of the axis O and the circumferential direction Dc, and a plurality of fin sections 26 which are provided at positions on the inner circumferential surface 21a of the seal main body 21 different from the hole group 22.

(Seal Main Body)

As shown in FIG. 3 to FIG. 5, the seal main body 21 forms a cavity C1 between the seal main body 21 and the outer circumferential surface 2a of the rotor 2. A length L1 of the cavity C1 in the radial direction is set such that the seal main body 21 and the rotor 2 do not come into contact with each other even when the rotor 2, from which self-excited oscillations are generated, is displaced somewhat.

(Hole Group)

The hole group 22 has a plurality of hole arrays 24 formed in an annular shape (a linear shape in a deployment view) while the plurality of holes 25 are disposed at intervals in the circumferential direction Dc.

(Hole Array)

The plurality of hole arrays 24 are provided at intervals in the direction of the axis O. The hole array 24 is provided on the inner circumferential surface 21a of the seal main body 21 throughout in the circumferential direction Dc.

(Hole)

Each of the holes 25 faces the outer circumferential surface 2a of the rotor 2 and is open toward an inner circumferential side. The holes 25 are formed in the radial direction and each has a circular cross-sectional shape with substantially the uniform diameter. The plurality of holes 25 aligned with the circumferential direction Dc are arranged in an annular shape (linearly in the deployment view), and the plurality of holes 25 aligned with the direction of the axis O are arranged linearly. Opening portions 25b of the holes 25 are arranged at equal intervals in the direction of the axis O and the circumferential direction Dc. In addition, a bottom surface 25c of each of the holes 25 is formed in a circular flat shape.

(Fin Section)

The fin sections 26 are provided only on the high pressure side HP and the low pressure side LP of the hole group 22 in the direction of the axis O. Each of the fin sections 26 protrudes toward the rotor 2, and extends annularly (linearly in a deployment view) on the inner circumferential surface 21a of the seal main body 21 throughout in the circumferential direction Dc. The fin sections 26 on the high pressure side HP are disposed along an end surface 21c of the seal main body 21 in the direction of the axis O. The fin sections 26 on the low pressure side LP are located on the low pressure side LP of the hole array 24 on the lowest pressure side LP in the direction of the axis O and disposed along the hole array 24 on the lowest pressure side LP.

The fin sections 26 are formed such that a thickness W2 in the direction of the axis O is uniform in the radial direction. The thickness W2 of the fin section 26 is a minimum wall thickness W1 or less of the seal main body 21, for example, greater than 0.01 times and less than 0.5 times the minimum wall thickness W1.

An end surface 26a of the fin section 26 on an inner side in the radial direction forms a clearance C2 between the end surface 26a and the outer circumferential surface 2a of the rotor 2. A length L2 of the clearance C2 in the radial direction is set to a size such that the steam G passing through the fin sections 26 is contracted toward the rotor 2. The length L1 of the cavity C1 in the radial direction is 1.1 times or more and 10 times or less the length L2 of the clearance C2 in the radial direction.

(Effects)

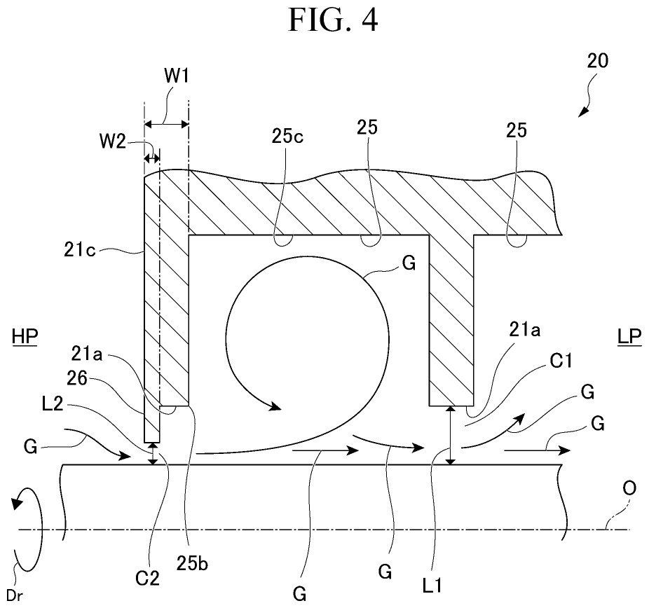

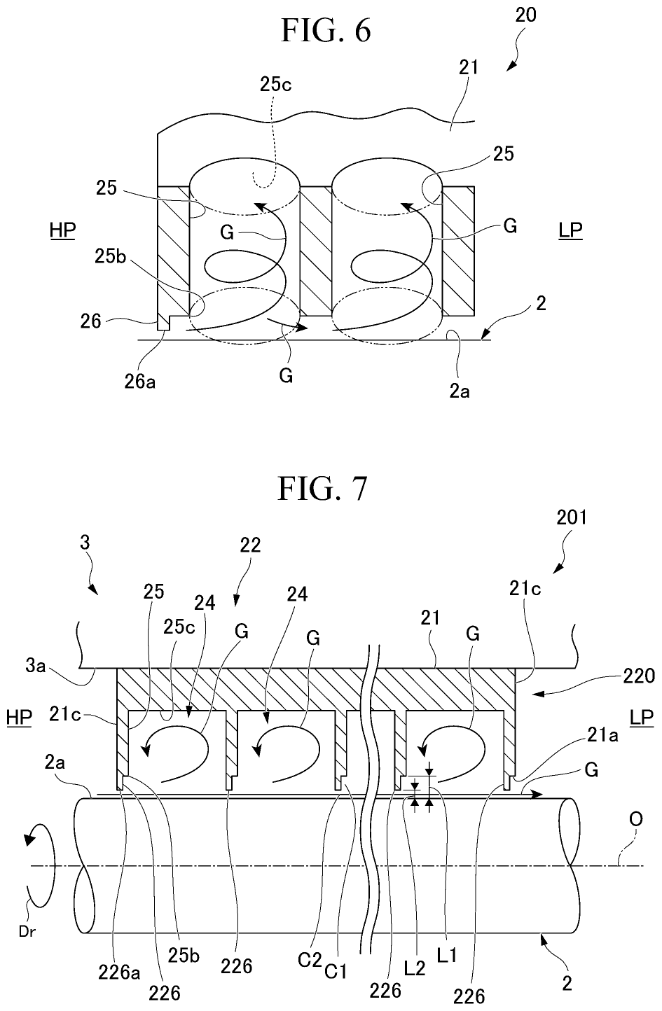

Next, effects of swirl reduction due to the hole pattern seal 20 will be described with reference to FIG. 3, FIG. 4 and FIG. 6.

Here, when the rotor 2 is rotated, a shearing force is applied from the rotor 2 to the steam G around the rotor 2 in the rotating direction Dr. The swirl having a velocity component in the circumferential direction Dc is generated by an action of the shearing force. The steam G including the swirl tends to flow from the high pressure side HP toward the low pressure side LP due to a pressure difference between both sides in the direction of the axis O.

First, the steam G including the swirl is contracted toward an inner side in the radial direction due to the clearance C2 between the end surface 26a of the fin section 26 on the highest pressure side HP of the hole pattern seal 20 and the outer circumferential surface 2a of the rotor 2. Some of the steam G that is contracted collides with the outer circumferential surface 2a of the rotor 2, and then, is expanded outward in the radial direction. The expanded steam G is guided to the hole 25 on the highest pressure side HP (the hole 25 belonging to the hole array 24 of the first row). The steam G guided to the hole 25 becomes a spiral vortex along the inner circumferential surface of the hole 25 as shown in FIG. 6 due to the velocity component in the circumferential direction Dc. Accordingly, the swirl included in the steam G collides with the inner circumferential surface of the hole 25 and then is reduced.

After that, the steam G is folded back toward the opening portions 25b at the bottom surfaces 25c, and moves toward the hole 25 on the low pressure side LP (the hole 25 belonging to the second hole array 24). The steam G is contracted again toward the inner side in the radial direction when moving between the two holes 25. Some of the steam G that is contracted is expanded again toward the outer side in the radial direction and guided to the hole 25 of the second row. Like in the hole 25 of the second row, the steam G becomes a spiral vortex along the inner circumferential surface of the hole 25, and the swirl is reduced like the first row. After that, the steam G advances toward the low pressure side LP, and in this process, some of the steam G repeats contraction and expansion as described above. That is, the above-mentioned action is repeated for the number of rows of the hole array 24. As a result, the swirl included in the steam G is reduced.

In the embodiment, the hole pattern seal 20 has the fin sections 26 provided on the inner circumferential surface 21a of the seal main body 21, protruding toward the rotor 2 and extending in the circumferential direction Dc, and having the thickness W2 equal to or smaller than the minimum wall thickness W1 of the seal main body 21. The fin sections 26 are provided on the high pressure side HP and the low pressure side LP of the hole group 22 in the direction of the axis O.

According to the embodiment, the steam G from the high pressure side HP toward the low pressure side LP is contracted toward an inner side in the radial direction with respect to the axis O by the fin sections 26. The contracted steam G collides with the outer circumferential surface 2a of the rotor 2 and expands outward in the radial direction. Accordingly, a flow rate of the steam G flowing into the holes 25 can be increased, and a vortex of the steam G generated in the holes 25 can be strengthened. Accordingly, a steady momentum of the steam G in the holes 25 can be increased. As the steady momentum of the steam G in the holes 25 is increased, fluctuation of the momentum of the steam G flowing into and out of the holes 25 is increased, and an exciting force applied to the rotor 2 due to the swirl is reduced. Accordingly, self-excited oscillation of the rotor 2 can be suppressed due to the swirl, and damping due to the hole pattern seal 20 can be improved.

Further, since the thickness W2 of the fin section 26 is equal to or smaller than the minimum wall thickness W1 of the seal main body 21, a contact area between the hole pattern seal 20 and the rotor 2 can be reduced. Accordingly, even when a displacement occurs in the rotor 2, an increase in contact heat between the hole pattern seal 20 and the rotor 2 can be suppressed. Accordingly, the rotor 2 can be deformed by the contact heat to increase eccentricity (unbalance) of the rotor 2, and a contact risk such as an increase in forced vibrations (unbalance vibrations) can be reduced.

In the embodiment, the plurality of holes 25 aligned with the circumferential direction Dc can be arranged in an annular shape, and the plurality of holes 25 aligned with the direction of the axis O can be arranged linearly.

Accordingly, an array pattern of the holes 25 can be uniformized in the circumferential direction Dc, and regularity of the flow of the steam G in the circumferential direction Dc can be improved. For this reason, in comparison with the case in which the holes 25 are arranged irregularly, a vortex of the steam G generated in the holes 25 can be strengthened, and the steady momentum of the steam G in the holes 25 can be increased. Accordingly, an exciting force applied to the rotor 2 due to the swirl is reduced. Accordingly, self-excited oscillation of the rotor 2 due to the swirl can be suppressed, and damping due to the hole pattern seal 20 can be further improved.

In the embodiment, the fin sections 26 are provided only on the high pressure side HP and the low pressure side LP of the hole group 22 in the direction of the axis O. Each of the fin sections 26 extends annularly throughout the inner circumferential surface 21a of the seal main body 21.

Accordingly, since the steam G entering between the hole pattern seal 20 and the rotor 2 at each of the fin sections 26 can be appropriately contracted, a vortex of the steam G in the holes 25 can be strengthened, and steady momentum of the steam G in the holes 25 can be increased. For this reason, an exciting force applied to the rotor 2 due to the swirl is reduced. Accordingly, self-excited oscillation of the rotor 2 due to the swirl can be suppressed, and damping due to the hole pattern seal 20 can be further improved.

Further, a leakage rate of the steam G can be reduced on both of the high pressure side HP and the low pressure side LP of the hole group 22. Accordingly, sealability of the hole pattern seal 20 can be maintained.

In addition, in comparison with the case in which the fin sections 26 are provided between the hole arrays 24, a contact area between the hole pattern seal 20 and the rotor 2 can be further reduced. Accordingly, even when a displacement occurs in the rotor 2, an increase in contact heat between the hole pattern seal 20 and the rotor 2 can be suppressed. Accordingly, the rotor 2 can be deformed by the contact heat to increase eccentricity (unbalance) of the rotor 2, and a contact risk such as an increase in forced vibrations (unbalance vibrations) or the like can be reduced.

In the first embodiment, while the fin sections 26 are formed in the radial direction to have the uniform thickness W2 in the direction of the axis O, there is no there is no limitation thereto. For example, the fin section 26 may be formed to be tapered toward the rotor 2.

In addition, the case in which the plurality of holes 25 are formed regularly such that the plurality of holes 25 aligned with the circumferential direction Dc are arranged annularly and the plurality of holes 25 aligned with the direction of the axis O are arranged linearly has been described in the first embodiment, there is no limitation thereto. For example, the plurality of holes 25 may be disposed in a zigzag pattern in the circumferential direction Dc and the direction of the axis O. In addition, the plurality of holes 25 may be formed irregularly.

### Second Embodiment

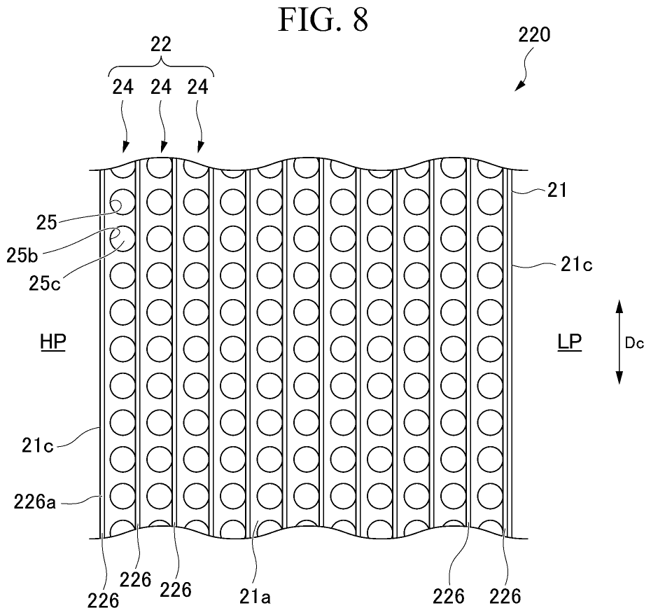

Hereinafter, a steam turbine 201 (an example of a rotary machine) according to a second embodiment of the present disclosure will be described with reference to FIG. 7 and FIG. 8. The same components in the second embodiment as those in the first embodiment are referred to as the same names and designated by the same reference signs, and description thereof will be omitted as appropriate.

As shown in FIG. 7 and FIG. 8, in a hole pattern seal 220 of the embodiment, like the first embodiment, the hole group 22 has a plurality of hole arrays 24, each in which a plurality of holes 25 are formed annularly in an annular shape at intervals in the circumferential direction Dc, formed at intervals in the direction of the axis O. In addition, fin sections 226 are provided on the high pressure side HP in the direction of the axis O for the entirety of the hole arrays 24. Further, the fin sections 226 are also provided on the low pressure side LP of the hole array 24 on the lowest pressure side LP in the direction of the axis O. Each of the fin sections 226 extends annularly in the circumferential direction Dc (linearly in a deployment view) along the hole array 24 adjacent to the high pressure side HP in the direction of the axis O. The fin section 226 located on the highest pressure side HP in the direction of the axis O extends in the circumferential direction Dc (linearly in a deployment view) along the end surface 21c in the direction of the axis O of the seal main body 21.

An end surface 226a on an inner side in the radial direction of each of the fin sections 226 is disposed at substantially the same position in the radial direction. That is, the length L2 in the radial direction of the clearance C2 of each of the fin sections 226 has substantially the same size.

The steam turbine 201 of the second embodiment has the same configuration as the steam turbine 1 of the first embodiment, and in addition to the same effects as the first embodiment, has the following effects.

In the embodiment, the fin sections 226 are provided on the high pressure side HP in the direction of the axis O for all the hole arrays 24, and each of the fin sections 226 extends in an annular shape throughout the entire inner circumferential surface 21a of the seal main body 21.

Accordingly, in addition to the high pressure side HP and the low pressure side LP of the hole group 22, a clearance C1 can be formed on the high pressure side HP of each of the hole arrays 24. For this reason, a leakage amount of the steam G can be reduced, and sealability of the hole pattern seal 220 can be improved.

Further, since the steam G can be contracted on the high pressure side HP of each of the hole arrays 24, a flow rate of the steam G flowing into each of the holes 25 can be increased. For this reason, a vortex of the steam G with a great flow speed is generated in each of the holes 25, and a steady momentum of the steam G in the holes 25 can be increased. Accordingly, self-excited oscillation of the rotor 2 due to the swirl can be suppressed, and damping due to the hole pattern seal 220 can be further improved.

### Third Embodiment

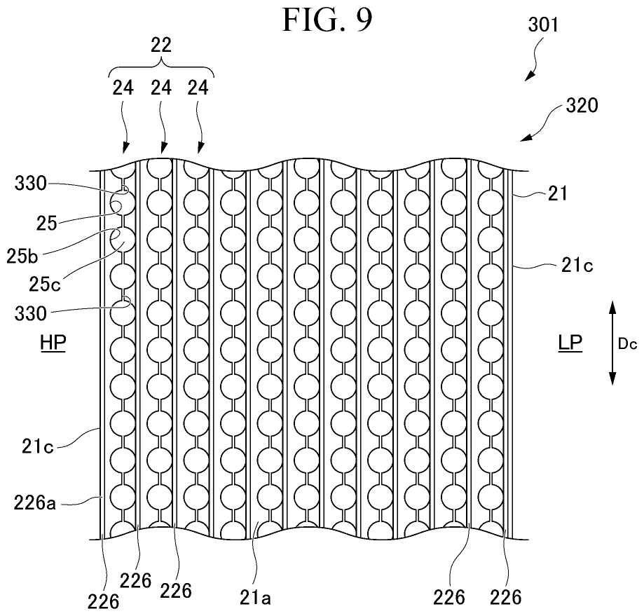

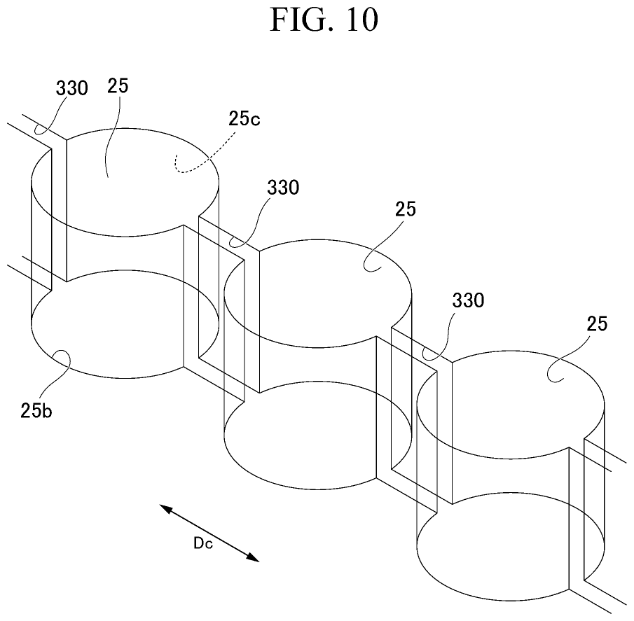

Hereinafter, a steam turbine 301 (an example of a rotary machine) according to a third embodiment of the present disclosure will be described with reference to FIG. 9 to FIG. 11. The same components in the third embodiment as those in the above-mentioned each embodiment are referred to as the same names and designated by the same reference signs, and description thereof will be omitted as appropriate.

As shown in FIG. 9 and FIG. 10, a hole pattern seal 320 of the embodiment further has a plurality of slits 330 configured to bring the plurality of holes 25 aligned with the circumferential direction Dc in communication with each other, in addition to the seal main body 21, the hole group 22 and the fin sections 226.

The slits 330 are provided between the holes 25 adjacent to each other in the circumferential direction Dc, and bring the holes 25 belonging to the same hole array 24 in communication with each other. The plurality of slits 330 aligned with the circumferential direction Dc are arranged annularly (linearly in a deployment view). The slit 330 is formed in the radial direction and is open toward the outer circumferential surface of the rotor 2. The length of the slit 330 in the radial direction is substantially equal to the length of the hole 25 in the radial direction. A thickness of the slit 330 in the direction of the axis O is uniform in the radial direction and the circumferential direction Dc.

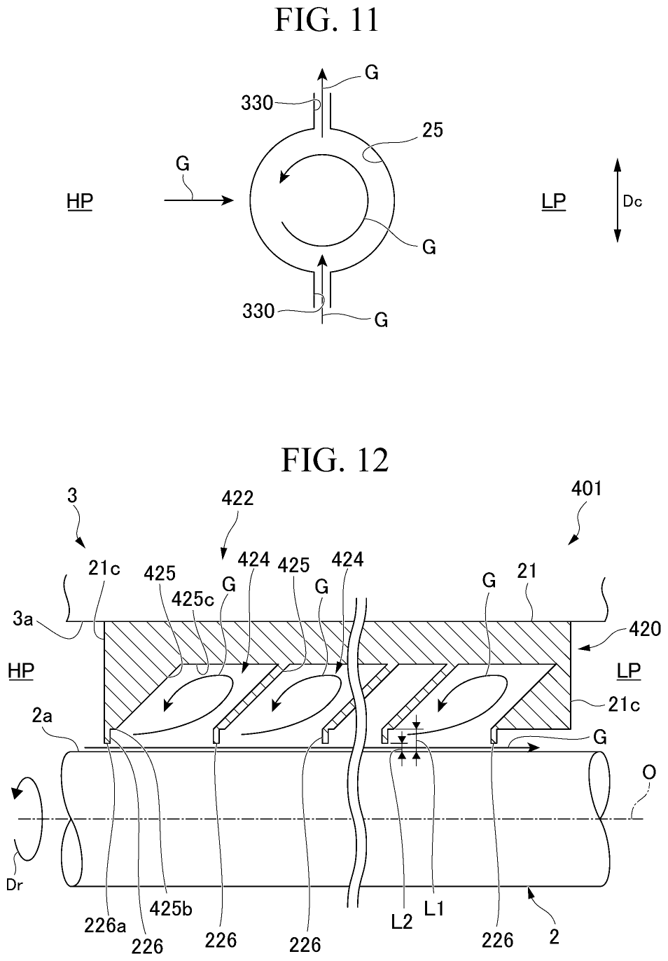

As shown in FIG. 11, in the embodiment, like the above-mentioned second embodiment, since the steam G is contracted by the fin sections 226 and then flows into each of the holes 25, a vortex of the steam G with a great flow speed is generated in each of the holes 25. The vortex of the steam G spirally flows along the inner circumferential surface of the hole 25.

The steam turbine 301 of the third embodiment has the same configuration as the steam turbine 1 of the first embodiment, and in addition to the same effects as the first embodiment, has the following effects.

In the embodiment, the hole pattern seal 320 has the slits 330 provided between the holes 25 adjacent to each other in the circumferential direction Dc and configured to bring the plurality of holes 25 aligned with the circumferential direction Dc in communication with each other.

Accordingly, the steam G can be appropriately guided to the vortex of the spiral steam G flowing along the inner circumferential surface of the hole 25 through the slits 330 from the holes 25 adjacent to each other in the circumferential direction. Since the vortex of the steam G in the hole 25 is accelerated by the steam G guided from the circumferential direction Dc, a steady momentum of the steam G in the hole 25 can be increased. Accordingly, self-excited oscillation of the rotor 2 due to the swirl can be suppressed and damping due to the hole pattern seal 320 can be further improved.

While the case in which the hole pattern seal 320 has the fin sections 226 provided on the high pressure side HP in the direction of the axis O for all the hole arrays 24 like the second embodiment has been described in the third embodiment, there is no limitation thereto. The fin sections 226 of the third embodiment may be provided on the high pressure side HP in the direction of the axis O for only some of the hole arrays 24, and for example, like the first embodiment, the fin sections 226 may be provided only on the high pressure side HP and the low pressure side LP of the hole group 22 in the direction of the axis O.

### Fourth Embodiment

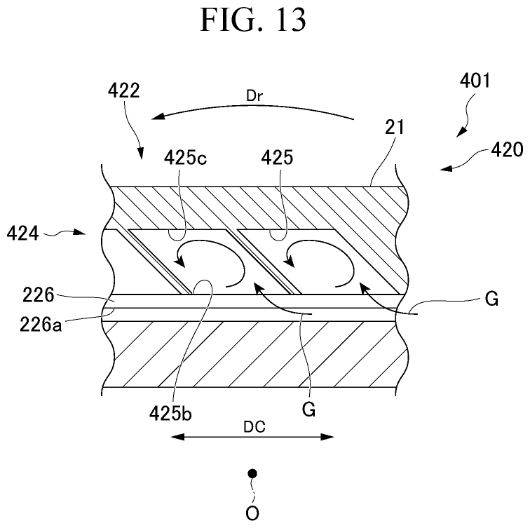

Hereinafter, a steam turbine 401 (an example of a rotary machine) according to a fourth embodiment of the present disclosure will be described with reference to FIG. 12 and FIG. 13. The same components in the fourth embodiment as those in the above-mentioned each embodiment are referred to as the same names and designated by the same reference signs, and description thereof will be omitted as appropriate.

As shown in FIG. 12 and FIG. 13, a hole pattern seal 420 of the embodiment has a hole group 422, in addition to the seal main body 21 and the fin sections 226.

In the hole group 422, like the first embodiment, hole arrays 424 extending in the circumferential direction Dc are provided at intervals in the direction of the axis O.

In addition, like the first embodiment, a plurality of holes 425 aligned with the circumferential direction Dc are arranged annularly (linearly in a deployment view), and the plurality of holes 425 aligned with the direction of the axis O are arranged linearly. These holes 425 are formed in a circular cross-sectional shape with substantially the same hole diameter. Opening portions 425b of the holes 425 are arranged at equal intervals in the direction of the axis O and the circumferential direction Dc. In addition, a bottom surface 425c of each of the holes 425 is formed in a flat circular shape.

As shown in FIG. 12, the hole 425 is inclined so that the bottom surface 425c is closer to the low-pressure side LP of the seal main body 21 than the opening portion 425b of the hole 425 as further away from the outer circumference of the rotor 2. Also, as shown in FIG. 13, the hole 425 is inclined so that the bottom surface 425c is closer to the forward side of the rotor 2 than the opening portion 425b in the rotating direction Dr thereof.

While an inclination angle of the hole 425 may be appropriately arranged, the hole 425 is preferably inclined within a range of, for example, 20 degrees or more and 70 degrees or less in the direction of the axis O and the circumferential direction with respect to the inner circumferential surface 21a of the seal main body 21, and preferably inclined at 45 degrees in the direction of the axis O and the circumferential direction.

The steam turbine 401 of the fourth embodiment has the same configuration as the steam turbine 1 of the first embodiment, and in addition to the same effects as the first embodiment, has the following effects.

While the steam G flows from the high pressure side HP toward the low pressure side LP along the outer circumferential surface 2a of the rotor 2, a shearing force is applied from the rotor 2 in the rotating direction Dr at this time. According to the application, the steam G spirally flows toward the low pressure side LP while rotating in the rotating direction Dr.

In the embodiment, the hole 425 is inclined so that the bottom surface 425c is closer to the low-pressure side LP of the seal main body 21 than the opening portion 425b as further away from the outer circumference of the rotor 2, and also inclined so that the bottom surface 425c is closer to the forward side of the rotor 2 than the opening portion 425b in the rotating direction Dr thereof. That is, the hole 425 is formed to accept a flow of the steam G along the outer circumferential surface 2a of the rotor 2.

For this reason, the steam G can flow well toward each of the holes 425. Accordingly, a flow rate of the steam G flowing into the holes 425 can be increased, and a vortex of the steam G generated in the holes 425 can be strengthened. Accordingly, a steady momentum of the steam G in the holes 425 can be increased. Accordingly, self-excited oscillation of the rotor 2 due to the swirl can be suppressed and damping due to the hole pattern seal 420 can be further improved.

In the fourth embodiment, while the case in which the hole pattern seal 420 has the fin sections 226 provided on the high pressure side HP in the direction of the axis O for all the hole arrays 424 like the second embodiment has been described, there is no limitation thereto. The fin sections 226 of the fourth embodiment may be provided on the high pressure side HP in the direction of the axis O only for some of the hole arrays 424, and for example, like the first embodiment, the fin sections 226 may be provided only on the high pressure side HP and the low pressure side LP of the hole group 422 in the direction of the axis O.

In addition, like the third embodiment, the slits 330 may be provided, and the slits 330 may bring the plurality of holes 425 aligned with the circumferential direction Dc in communication with each other.

### Fifth Embodiment

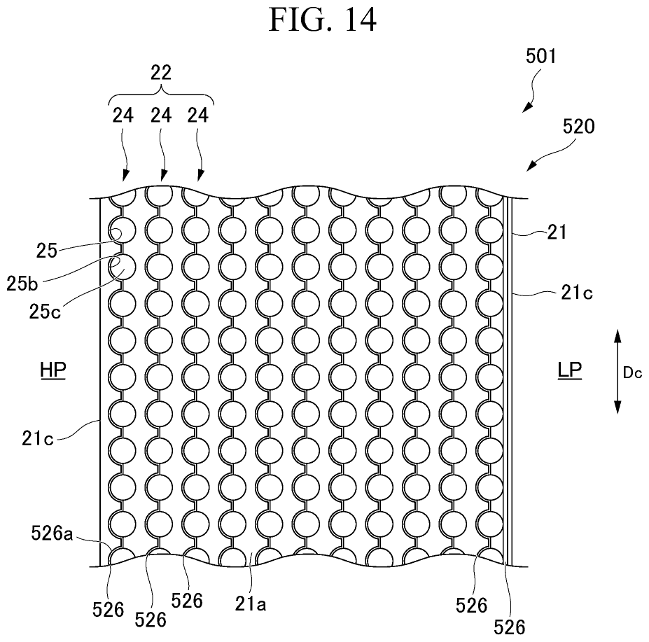

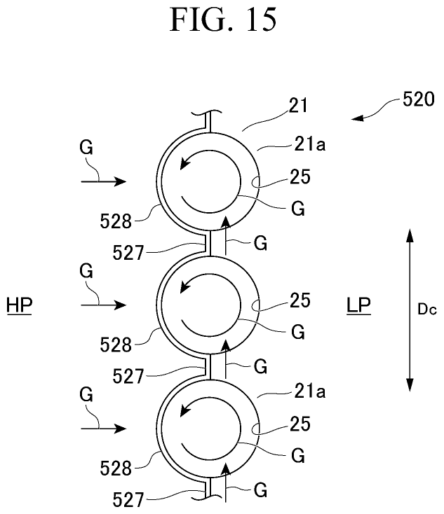

Hereinafter, a steam turbine 501 (an example of a rotary machine) according to a fifth embodiment of the present disclosure will be described with reference to FIG. 14 and FIG. 15. The same components in the fifth embodiment as those in the above-mentioned each embodiment are referred to as the same names and designated by the same reference signs, and description thereof will be omitted as appropriate.

As shown in FIG. 14 and FIG. 15, in a hole pattern seal 520 of the embodiment, fin sections 526 are provided on the high pressure side HP in the direction of the axis O for all the hole arrays 24. The fin sections 526 are provided on the inner circumferential surface 21a of the seal main body 21 throughout in the circumferential direction Dc. Each of the fin sections 526 has a plurality of half-circular arc portions 528 each having the half-circular arc shape risen toward the high-pressure side HP of the seal main body 21 in the direction of the axis O to surround the entire circumference of each of the holes 25 when seen in the radial direction with respect to the axis O, and fin connecting portions 527 connecting the half-circular arc portions 528 adjacent to each other in the circumferential direction Dc. Specifically, each of the half-circular arc portions 528 has the half-circular arc shape along the opening portions 25b of the holes 25 adjacent to the low pressure side LP in the direction of the axis O. The half-circular arc portions 528 are protruding inward in the radial direction. The half-circular arc portions 528 adjacent to each other in the circumferential direction Dc have end portions in the circumferential direction Dc connected by the fin connecting portions 527. The fin connecting portions 527 protrude inward in the radial direction at a height substantially equal to that of the half-circular arc portions 528 and extend in the circumferential direction Dc. The plurality of half-circular arc portions 528 and the fin connecting portions 527 aligned with the circumferential direction Dc are integrally formed in an annular shape.

However, like the fin sections 26 of the first embodiment, the fin sections 526 located on the lowest pressure side LP in the direction of the axis O are provided annularly (linearly in a deployment view) on the inner circumferential surface 21a of the seal main body 21 throughout in the circumferential direction Dc.

End surfaces 526a of the fin sections 526 on the inner side in the radial direction are disposed at substantially the same position in all radial direction with respect to the axis. That is, a length L2 of a clearance C of each of the fin sections 526 has substantially the same size.

The steam turbine 501 of the fifth embodiment has the same configuration as the steam turbine 1 of the first embodiment, and in addition to the same effects as the first embodiment, has the following effects.

In the embodiment, the fin sections 526 have the half-circular arc portions 528 each having the half-circular arc shape risen toward the high-pressure side HP of the seal main body 21 in the direction of the axis O to surround half of the holes 25 when seen in the radial direction with respect to the axis O.

While the steam G tends to flow into the holes 25 from the circumferential direction Dc, according to the embodiment, the half-circular arc portions 528 can suppress the steam G flowing from the high pressure side HP of the holes 25 in the circumferential direction Dc from flowing thereinto. Further, since the half-circular arc portions 528 are not present on the low pressure side LP of the holes 25, the steam G flowing in the circumferential direction Dc can easily flow into the holes 25 from the low pressure side LP.

Incidentally, a vortex of the steam G generated in the holes 25 flows in a direction opposite to the steam G to flow in the circumferential direction Dc on the high pressure side HP, and flows in the same direction as the steam G to flow in the circumferential direction Dc on the low pressure side LP. For this reason, a vortex of the steam G generated in the holes 25 can be strengthened by causing the steam G to flow in the circumferential direction Dc from the low pressure side LP of the holes 25. Accordingly, a steady momentum in the holes 25 can be increased. Accordingly, self-excited oscillation of the rotor 2 due to the swirl can be suppressed and damping due to the hole pattern seal 520 can be further improved.

While the case in which the fin connecting portions 527 connect the half-circular arc portions 528 adjacent to each other in the circumferential direction Dc has been described in the fifth embodiment, there is no limitation thereto. The fin connecting portions 527 may not be provided or the plurality of half-circular arc portions 528 may be provided independently from each other. In addition, among the plurality of fin sections 526, only some of the fin sections 526 may have the fin connecting portions 527 and the half-circular arc portions 528. In addition, in one of the fin sections 526, some of the holes 25 may have the half-circular arc portions 528 instead of all of the holes 25 belonging to 24 rows adjacent to each other in the direction of the axis O.

In the fifth embodiment, while the case in which the hole pattern seal 520 have the fin sections 526 provided on the high pressure side HP in the direction of the axis O for all of the hole arrays 24 like the second embodiment has been described, there is no limitation thereto. The fin sections 526 of the fourth embodiment may be provided on the high pressure side HP in the direction of the axis O only for some of the hole arrays 24, or for example, like the first embodiment, the fin sections 526 may be provided only on the high pressure side HP and the low pressure side LP of the hole group 22 in the direction of the axis O.

In addition, the slits 330 may be provided like the third embodiment, or the slits 330 may bring the plurality of holes 25 aligned with the circumferential direction Dc in communication with each other.

### Sixth Embodiment

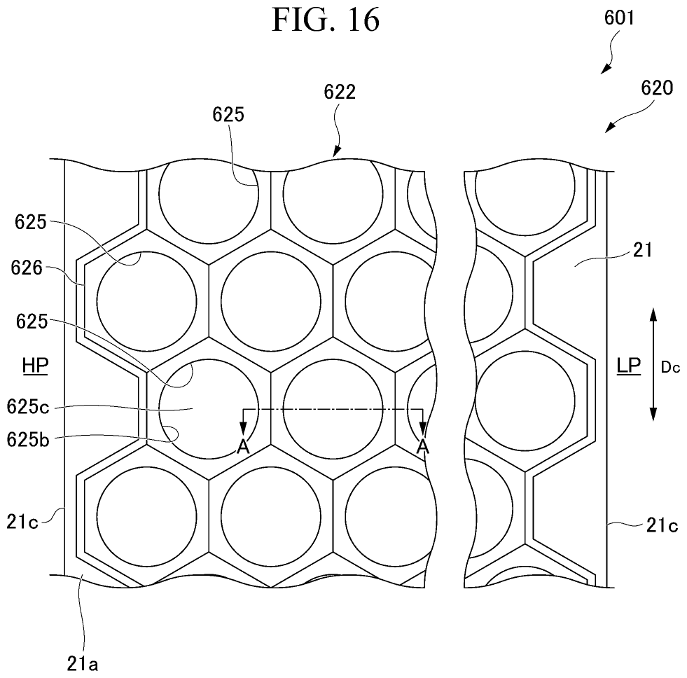

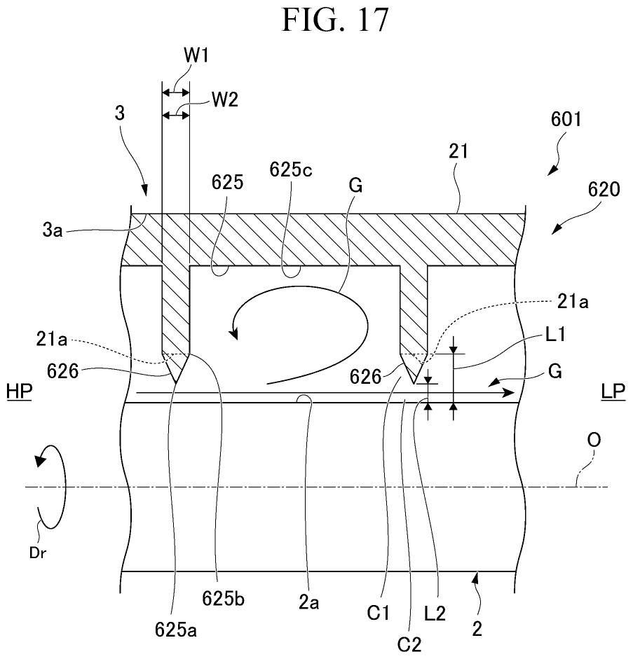

Hereinafter, a steam turbine 601 (an example of a rotary machine) according to a sixth embodiment of the present disclosure will be described with reference to FIG. 16 and FIG. 17. The same components in the sixth embodiment as those in the above-mentioned each embodiment are referred to as the same names and designated by the same reference signs, and description thereof will be omitted as appropriate.

As shown in FIG. 16 and FIG. 17, a hole pattern seal 620 of the embodiment has a hole group 622 and fin sections 626, in addition to the seal main body 21.

A plurality of holes 625 as elements of the hole group 622 are arranged on polygonal grids when seen in the radial direction. Specifically, the plurality of holes 625 are arranged on regular hexagonal grids.

In addition, like the first embodiment, the holes 625 is formed in the radial direction, and are formed in a substantially oval shape with a uniform hole diameter. Opening portions 625b of the holes 625 are arranged at equal intervals in the direction of the axis O and the circumferential direction Dc. In addition, a bottom surface 625c of each of the holes 625 is formed in a flat circular shape.

The plurality of fin sections 626 are provided on polygonal grids when seen in the radial direction to surround the entire circumference of the opening portion 625b of each of the holes 625 on the side of the rotor 2. Specifically, the plurality of fin sections 626 are provided in a honeycomb shape formed by arranging a plurality of regular hexagons. Further, the fin sections 626 adjacent to each other are connected by end portions. In addition, each of the fin sections 626 is formed in a shape tapered toward the rotor 2.

End surfaces 626a of the fin sections 626 on the inner side in the radial direction are disposed at substantially the same position throughout in the radial direction. That is, all the lengths L2 of the clearances C2 of the fin sections 626 have substantially the same size.

The steam turbine 601 of the sixth embodiment has the same configuration as the steam turbine 1 of the first embodiment, and in addition to the same effects as the first embodiment, has the following effects.

The plurality of holes 625 are arranged on polygonal grids. The fin sections 626 are provided to surround the opening portions 625b of the holes 625 and formed in a shape tapered as they approach the rotor 2.

Accordingly, since the steam G can be contracted on the high pressure side HP of each of the holes 625 by the fin sections 626, a flow rate of the steam G flowing through each of the holes 625 can be increased. For this reason, a vortex of the steam G with a great flow speed can be generated in each of the holes 625, and a steady momentum of the steam G in the holes 625 can be increased. Accordingly, as same as the fin sections 626 are formed in an annular shape extending in the circumferential direction, an exciting force applied to the rotor 2 due to the swirl can be reduced and damping due to the hole pattern seal 220 can be improved.

Further, since the fin section 626 is tapered toward the rotor 2, a contact area between the hole pattern seal 620 and the rotor 2 can be reduced. Accordingly, even when a displacement occurs in the rotor 2, an increase in contact heat between the hole pattern seal 620 and the rotor 2 can be suppressed. Accordingly, the rotor 2 can be deformed by the contact heat to increase eccentricity (unbalance) of the rotor 2, and a contact risk such as an increase in forced vibrations (unbalance vibrations) or the like can be reduced.

In the sixth embodiment, while the plurality of holes 625 are arranged on the hexagonal grids and the plurality of fin sections 626 are provided in a honeycomb shape formed by arranging a plurality of hexagonal shapes to surround each of the holes 625, there is no limitation thereto. For example, the plurality of fin sections 626 may be provided in a shape obtained by arranging a plurality of regular triangles to surround each of the holes 625. In addition, when the plurality of holes 625 are arranged in the same linear shape as in the first embodiment and an array pattern of the plurality of holes 625 is a rectangular grid shape, the plurality of fin sections 626 may be provided in a shape obtained by arranging a plurality of rectangular shapes to surround each of the holes 625.

### Seventh Embodiment

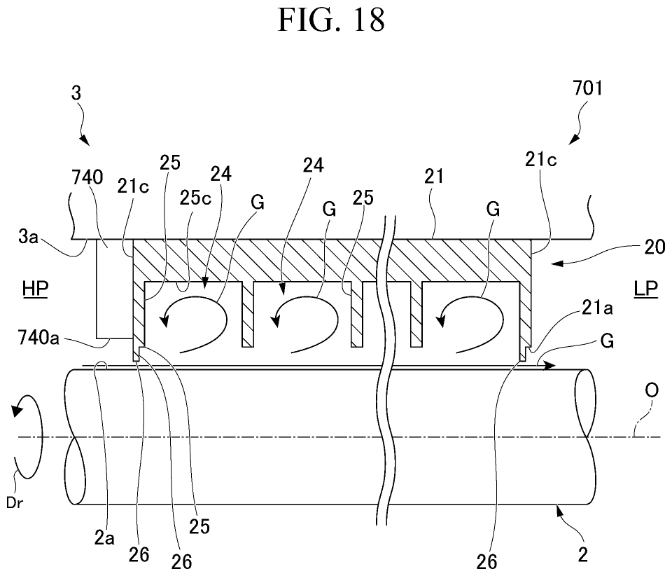

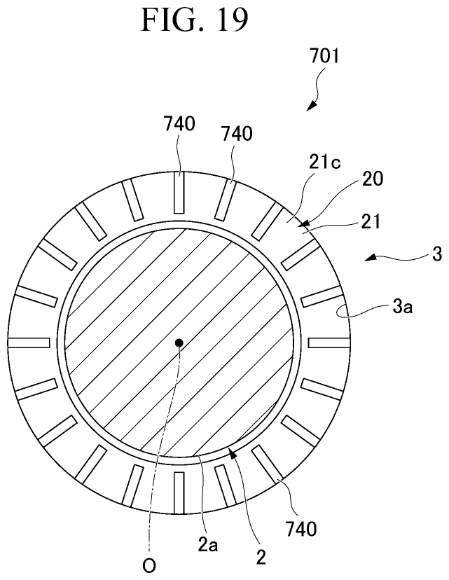

A steam turbine 701 (an example of a rotary machine) according to a seventh embodiment of the present disclosure will be described with reference to FIG. 18 and FIG. 19. The same components in the seventh embodiment as those in the above-mentioned each embodiment are referred to as the same names and designated by the same reference signs, and description thereof will be omitted as appropriate.

As shown in FIG. 18 and FIG. 19, the steam turbine 701 of the embodiment includes the hole pattern seal 20 of the first embodiment, and a plurality of swirl brakes 740 closer to the high pressure side HP than the hole pattern seal 20 in the direction of the axis O. The plurality of swirl brakes 740 are provided to be arranged in the circumferential direction Dc on the outer circumferential side of the rotor 2 while being fixed to the inner circumferential surface 3a of the dummy ring 3. The swirl brake 740 is a thin plate-shaped member extending in the direction of the axis O and the radial direction. That is, the swirl brake 740 is oriented across the circumferential direction Dc. The swirl brake 740 is formed in a rectangular shape having one side extending in the direction of the axis O when seen in the circumferential direction Dc. An end surface 740a of the swirl brake 740 on the inner side in the radial direction is located on a further inner side than the inner circumferential surface 21a of the seal main body 21 in the radial direction (on the side of the rotor 2) and located on a further outer side in the radial direction than the end surface 26a of the fin section 26 on the inner side in the radial direction.

The steam turbine 701 of the seventh embodiment has the same configuration as the steam turbine 1 of the first embodiment, and in addition to the same effects as the first embodiment, has the following effects.

In the embodiment, the swirl brake 740 having the plate shape oriented across the circumferential direction Dc is provided close to the high pressure side HP than the hole pattern seal 20 in the direction of the axis O.

Accordingly, after prohibiting the flow of the steam G in the circumferential direction Dc by the swirl brake 740 and reducing the swirl, the steam G can flow into the hole pattern seal 20. Accordingly, damping as the entire steam turbine 701 can be further improved.

While the case in which the swirl brake 740 is provided on the hole pattern seal 20 of first embodiment has been described in the seventh embodiment, there is no limitation thereto. The swirl brake 740 may be provided on the hole pattern seal 220, 320, 420, 520 or 620 of the second to sixth embodiments.

In the seventh embodiment, while the end surface 740a of the swirl brake 740 on the inner side in the radial direction is located on a further outer side in the radial direction than the end surface 26a of the fin section 26 on the inner side in the radial direction, the end surfaces 26a of the fin sections 26 may be located at the same position in the radial direction.

### Other Embodiments

Hereinabove, while the embodiments of the present disclosure have been described in detail with reference to the accompanying drawings, a specific configuration is not limited to the embodiment and design changes may be made without departing from the spirit of the present disclosure. The embodiments and variants thereof may be combined as appropriate.

Further, in the embodiment, while the steam turbine 1, 201, 301, 401, 501, 601 or 701 has been exemplified as an example of the rotary machine, there is no limitation thereto. The rotary machine may be, for example, a centrifugal compressor.

Further, in the embodiment, while the holes 25, 425 or 625 are formed in a circular cross-sectional shape with substantially the same hole diameter, there is no limitation thereto. A shape of the hole 25, 425 or 625 is not limited to the shape, and for example, may be a polygonal cross-sectional shape. Inner diameters of the holes 25, 425 or 625 are not necessarily all the same and may vary if necessary.

### Supplementary Statements

The rotary machine disclosed in each of the embodiments is ascertained, for example, as follows.

(1) The rotary machine (the steam turbine 1, 201, 301, 401, 501, 601 or 701) according to a first aspect includes the rotor 2 lying in the direction of the axis O and having the outer circumferential surface 2a with a uniform outer diameter throughout in the direction of the axis O, the annular member (the dummy ring 3) which is disposed on the outer circumferential side of the rotor 2 and which is allowed to rotate relative to the rotor 2 around the axis O, and the hole pattern seal 20, 220, 320, 420, 520 or 620 which is fixed to the annular member and partitioning a space between the rotor 2 and the annular member into the high-pressure side HP close to one end of the hole pattern seal and the low-pressure side LP close to the other end, the hole pattern seal 20, 220, 320, 420, 520 or 620 being provided with the annular seal main body 21 covering the outer circumference of the rotor 2, the hole group 22, 422 or 622 which is provided on the inner circumferential surface 21a of the seal main body 21 and having the plurality of holes 25 facing the outer circumferential surface 2a of the rotor 2, the plurality of the holes 25 being aligned at intervals in the direction of the axis O and the circumferential direction Dc of the axis O, and the fin sections 26, 226, 526 or 626 which are provided on the inner circumferential surface 21a of the seal main body 21 throughout in the circumferential direction Dc, and each protruding toward the rotor 2, each of the fin sections having the thickness W2 in the direction of the axis O equal to or smaller than the thickness W1 of the thinnest part of the seal main body 21. The fin sections 26, 226, 526 or 626 are provided on at least the high=pressure side HP and the low=pressure side LP of the seal main body 21 in the direction of the axis O.

According to the aspect, the fluid from the high pressure side HP toward the low pressure side LP is contracted inward in the radial direction with respect to the axis O by the fin sections 26, 226, 526 or 626. The contracted fluid collides with the outer circumferential surface 2a of the rotor 2 to expand outward in the radial direction. Accordingly, a flow rate of the fluid flowing into the holes 25, 425 or 625 can be increased and a vortex of the fluid generated in the holes 25, 425 or 625 can be strengthened. Accordingly, since a steady momentum of the fluid in the holes 25, 425 or 625 can be increased, an exciting force applied to the rotor 2 due to the swirl can be reduced. Further, since the thickness W2 of the fin sections 26, 226, 526 or 626 is equal to or smaller than the minimum wall thickness W1 of the seal main body 21, a contact area between the hole pattern seal 20, 220, 320, 420, 520 or 620 and the rotor 2 can be reduced.

In each of the aspects, as an example of the rotary machine, a centrifugal compressor or the like is exemplified in addition to the steam turbine. In addition, as an example of the fluid, for example, the steam G or the like is exemplified.

(2) According to the rotary machine (the steam turbine 1, 201, 301, 401, 501 or 701) of a second aspect, in the rotary machine of the first aspect, the plurality of holes 25 or 425 aligned with the circumferential direction Dc may be annularly arranged, and the plurality of holes 25 or 425 aligned in the direction of the axis O may be linearly arranged.

Accordingly, an array pattern of the holes 25 or 425 can be uniformized in the circumferential direction Dc, and regularity of the flow of the fluid in the circumferential direction Dc can be improved. For this reason, in comparison with the case in which the holes 25 or 425 are arranged irregularly, a vortex of the fluid generated in the holes 25 or 425 can be strengthened, and a steady momentum of the fluid in the holes 25 or 425 can be increased.

(3) According to the rotary machine (the steam turbine 1) of a third aspect, in the rotary machine of the first or second aspect, the fin sections 26 may be provided on the high-pressure side HP or the low-pressure side LP of the seal main body 21 in the direction of the axis O, and each of the fin sections 26 may extend annularly throughout the entire inner circumferential surface 21a of the seal main body 21.

Accordingly, since the fluid entering between the hole pattern seal 20 and the rotor 2 can be appropriately contracted at each of the fin sections 26, a vortex of the fluid in the holes 25 can be strengthened, and a steady momentum of the fluid in the holes 25 can be increased. Further, a contact area between the hole pattern seal 20 and the rotor 2 can be further reduced while maintaining sealability of the hole pattern seal 20.

(4) According to the rotary machine (the steam turbine 201, 301 or 401) of a fourth aspect, in the rotary machine of the first or second aspect, the hole group 22 or 422 may have the plurality of hole arrays 24 or 424, each in which the plurality of holes 25 or 425 are aligned annularly at intervals in the circumferential direction Dc, hole at intervals in the direction of the axis O, the fin sections 226 may be provided on the high-pressure side HP of the seal main body 21 in the direction of the axis O for all of the hole arrays 24, and each of the fin sections 226 may extend annularly throughout the entire inner circumferential surface 21a of the seal main body 21.

Accordingly, a leakage amount of the fluid can be reduced, and sealability of the hole pattern seal 220, 320 or 420 can be improved. Further, since the fluid can be contracted on the high pressure side HP of each of the hole arrays 24, a flow rate of the fluid flowing into each of the holes 25 can be increased. For this reason, a vortex of the steam G with a great flow speed can be generated in each of the holes 25, and a steady momentum of the fluid in the holes 25 can be increased.

(5) According to the rotary machine (the steam turbine 301) of a fifth aspect, in the rotary machine of any one of the first to fourth aspects, the hole pattern seal 320 may have the slits 330 provided between the holes 25 adjacent to each other in the circumferential direction Dc and configured to secure the communication between the plurality of holes 25 aligned in the circumferential direction Dc.

Accordingly, the fluid can be appropriately guided to the vortex of the spiral fluid flowing along the inner circumferential surface of the hole 25 through the slits 330 from the holes 25 adjacent to each other in the circumferential direction. Since the vortex of the fluid in the holes 25 is accelerated by the fluid guided from the circumferential direction Dc, a steady momentum of the fluid in the holes 25 can be increased.

(6) According to the rotary machine (the steam turbine 401) of a sixth aspect, in the rotary machine of any one of the first to fifth aspects, each hole 425 may be inclined so that the bottom surface 425c of the hole 425 is closer to the low-pressure side LP of the seal main body 21 than the opening portion 425b of the hole 425 as further away from the outer circumference of the rotor 2, and also inclined so that the bottom surface 425c of the hole 425 is closer to a forward side of the rotor 2 than the opening portion 425b in a rotating direction Dr thereof.

The fluid flows from the high pressure side HP toward the low pressure side LP in the direction of the axis O and flows toward the rotating direction of the rotor 2 in the circumferential direction Dc. For this reason, according to the aspect, the fluid can flow toward each of the holes 425 well. Accordingly, a flow rate of the fluid flowing into the holes 425 can be increased, and a vortex of the fluid generated in the holes 425 can be strengthened. Accordingly, a steady momentum of the fluid in the holes 425 can be increased.

(7) According to the rotary machine (the steam turbine 501) of a seventh aspect, in the rotary machine of any one of the first to sixth aspects, the fin section 526 may have the half-circular arc portions 528 each having the -half-circular arc shape risen toward the high-pressure side HP of the seal main body 21 in the direction of the axis O to surround half of the hole 25 when seen in the radial direction with respect to the axis O.

While the fluid tends to flow into the holes 25 from the circumferential direction Dc, according to the aspect, the half-circular arc portions 528 can suppress the fluid flowing in the circumferential direction Dc from the high pressure side HP of the holes 25 from flowing thereinto. Further, since the half-circular arc portions 528 are not present on the low pressure side LP of the holes 25, the fluid flowing in the circumferential direction Dc can easily flow into the holes 25 from the low pressure side LP. Accordingly, a vortex of the fluid generated in the holes 25 can be strengthened by the fluid flowing in the circumferential direction Dc. Accordingly, a steady momentum in the holes 25 can be increased.

(8) According to the rotary machine (the steam turbine 601) of an eighth aspect, in the rotary machine of the first aspect, the plurality of holes 625 may be arranged on the polygonal grids, and each fin section 626 may be formed so as to surround the entire circumference of the opening portion 625b of each of the holes 625 arranged on the polygonal grids and may have the shape tapered toward the rotor 2.

Accordingly, since the fluid is contracted on the high pressure side HP of each of the holes 625 by the fin sections 626, a flow rate of the fluid flowing into each of the holes 625 can be increased. For this reason, a vortex of the fluid with a great flow speed is generated in each of the holes 625, and a steady momentum of the fluid in the holes 625 can be increased. Accordingly, an exciting force applied to the rotor 2 due to the swirl can be reduced to the same extent as when the fin sections 626 are formed in an annular shape extending in the circumferential direction. Further, since the fin section 626 is tapered toward the rotor 2, a contact area between the hole pattern seal 620 and the rotor 2 can be reduced.

(9) According to the rotary machine (the steam turbine 701) of a ninth aspect, in the rotary machine of any one of the first to eighth aspects, the rotary machine may include the swirl brake 740 having the plate shape oriented across the circumferential direction Dc and which is provided on the high-pressure side HP of the seal main body 21 with respect to the hole pattern seal 20, 220, 320, 420, 520 or 620 in the direction of the axis O.

Accordingly, after prohibiting the flow of the fluid in the circumferential direction Dc by the swirl brake 740 and reducing the swirl, the fluid can flow into the hole pattern seal 20, 220, 320, 420, 520 or 620.

(10) The rotary machine (the steam turbine 601) of a tenth aspect includes the rotor 2 lying in the direction of the axis O and having the outer circumferential surface 2a with a uniform outer diameter throughout in the direction of the axis O, the annular member (the dummy ring 3) which is disposed on the outer circumferential side of the rotor 2 and which is allowed to rotate relative to the rotor 2 around the axis O, and the hole pattern seal 620 which is fixed to the annular member and partitioning the space between the rotor 2 and the annular member into the high-pressure side HP close to one end of the hole pattern seal and the low-pressure side LP close to the other end, the hole pattern seal 620 being provided with the annular seal main body 21 covering the outer circumference of the rotor 2, the plurality of holes 25 formed on the inner circumferential surface 21a of the seal main body 21 at intervals in the direction of the axis O and the circumferential direction Dc of the axis O and facing the outer circumferential surface 2a of the rotor 2, and the fin sections 626 which are provided on the inner circumferential surface 21a of the seal main body 21 throughout in the circumferential direction Dc and each protruding toward the rotor 2, and each of the fin sections having the thickness W2 in the direction of the axis O equal to or smaller than the thickness W1 of the thinnest part of the seal main body 21, the plurality of holes 625 being arranged in the polygonal grids, and each fin section 626 is formed so as to surround the entire circumference of an opening portion 625b of each of the holes 625 arranged on the polygonal grids and has a shape tapered toward the rotor 2.

### EXPLANATION OF REFERENCES

1 Steam turbine (rotary machine)
2 Rotor
2a Outer circumferential surface
3 Dummy ring (annular member)
3a Inner circumferential surface
4 Seal member
5 Blade ring
6 Inner wheel chamber
7 Outer wheel chamber
8 Flow channel
10 Steam supply pipe
12 Exhaust port
20 Hole pattern seal
21 Seal main body
21a Inner circumferential surface
21c End surface
22 Hole group
24 Hole array
25 Hole
25b Opening portion
25c Bottom surface
26 Fin section
26a End surface
201 Steam turbine (rotary machine)
220 Hole pattern seal
226 Fin section
226a End surface
301 Steam turbine (rotary machine)
320 Hole pattern seal
330 Slit
401 Steam turbine (rotary machine)
420 Hole pattern seal
422 Hole group
424 Hole array
425 Hole
425b Opening portion
425c Bottom surface
501 Steam turbine (rotary machine)
520 Hole pattern seal
526 Fin section
526a End surface
527 Fin connecting portion
528 Half-circular arc portion
601 Steam turbine (rotary machine)
620 Hole pattern seal
622 Hole group
625 Hole
625b Opening portion
625c Bottom surface
626 Fin section
626a End surface
701 Steam turbine (rotary machine)
740 Swirl brake
740a End surface
C1 Cavity
C2 Clearance
Dc Circumferential direction
Dr Rotating direction
G Steam
HP High pressure side
L1 Length
L2 Length
LP Low pressure side
O Axis
W1 Minimum wall thickness
W2 Thickness

What is claimed is:

1. A rotary machine comprising:
a rotor lying in a direction of an axis and having an outer circumferential surface with a uniform outer diameter throughout in the direction of the axis;
an annular member which is disposed on an outer circumferential side of the rotor and which is allowed to rotate relative to the rotor around the axis; and
a hole pattern seal which is fixed to the annular member and partitioning a space between the rotor and the annular member into a high-pressure side close to one end of the hole pattern seal and a low-pressure side close to the other end,
wherein the hole pattern seal is provided with:
an annular seal main body covering an outer circumference of the rotor;
a hole group which is provided on an inner circumferential surface of the seal main body and having a plurality of holes facing the outer circumferential surface of the rotor, the plurality of holes being aligned at intervals in the direction of the axis and a circumferential direction of the axis; and
fin sections which are provided on the inner circumferential surface of the seal main body throughout in the circumferential direction and each protruding toward the rotor, each of the fin sections having the thickness in the direction of the axis equal to or smaller than that of the thinnest part of the seal main body, wherein
the fin sections are provided on at least the high-pressure side and the low-pressure side of the seal main body in the direction of the axis.

2. The rotary machine according to claim 1, wherein the plurality of holes aligned with the circumferential direction are annularly arranged, and
the plurality of holes aligned in the direction of the axis are linearly arranged.

3. The rotary machine according to claim 1, wherein the fin sections are provided on the high-pressure side or the low-pressure side of the seal main body in the direction of the axis, and
each of the fin sections extends annularly throughout the entire inner circumferential surface of the seal main body.

4. The rotary machine according to claim 1, wherein the hole group has a plurality of hole arrays, each in which the plurality of holes are aligned annularly at intervals in the circumferential direction, at intervals in the direction of the axis,
the fin sections are provided on the high-pressure side of the seal main body in the direction of the axis for all of the hole arrays, and
each of the fin sections extends annularly throughout the entire inner circumferential surface of the seal main body.

5. The rotary machine according to claim 1, wherein the hole pattern seal has slits provided between the holes adjacent to each other in the circumferential direction and configured to secure a communication between the plurality of holes aligned in the circumferential direction.

6. The rotary machine according to claim 1, wherein each hole is inclined so that a bottom surface of the hole is closer to the low-pressure side of the seal main body than an opening portion of the hole as further away from the outer circumference of the rotor, and also inclined so that the bottom surface of the hole is closer to a forward side of the rotor than the opening portion in a rotation direction thereof.

7. The rotary machine according to claim 1, wherein the fin section has half-circular arc portions each having a half-circular arc shape risen toward the high-pressure side of the seal main body in the direction of the axis to surround half of the hole when seen in a radial direction with respect to the axis.

8. The rotary machine according to claim 1, wherein the plurality of holes are arranged on polygonal grids, and
each fin section is formed so as to surround the entire circumference of an opening portion of each of the holes arranged on the polygonal grids and has a shape tapered toward the rotor.

9. The rotary machine according to claim 1, further comprising a swirl brake having a plate shape oriented across the circumferential direction and which is provided on the high-pressure side of the seal main body with respect to the hole pattern seal in the direction of the axis.

10. A rotary machine comprising:
a rotor lying in a direction of an axis and having an outer circumferential surface with a uniform outer diameter throughout in the direction of the axis;
an annular member which is disposed on an outer circumferential side of the rotor and which is allowed to rotate relative to the rotor around the axis; and
a hole pattern seal which is fixed to the annular member and partitioning a space between the rotor and the annular member into a high-pressure side close to one end of the hole pattern seal and a low-pressure side close to the other end,
wherein the hole pattern seal is provided with:
an annular seal main body covering an outer circumference of the rotor;
a plurality of holes formed on an inner circumferential surface of the seal main body at intervals in the direction of the axis and a circumferential direction of the axis and facing the outer circumferential surface of the rotor; and
fin sections which are provided on the inner circumferential surface of the seal main body throughout in the circumferential direction and each protruding toward the rotor, each of the fin sections having the thickness in the direction of the axis equal to or smaller than that of the thinnest part of the seal main body, wherein
the plurality of holes are arranged on polygonal grids, and
each fin section is formed so as to surround the entire circumference of an opening portion of each of the holes arranged on the polygonal grids and has a shape tapered toward the rotor.
